(19) United States
(12) Patent Application Publication
(10) Pub. No.: US 2009/0199790 A1
(43) Pub. Date: Aug. 13, 2009

(54) Engine control strategy

(76) Inventors: Geoffrey Paul Cathcart, Western Australia (AU); Alexander Zubko, Western Australia (AU)

Correspondence Address: HARNESS, DICKEY & PIERCE, P.L.C., P.O. BOX 8910, RESTON, VA, 20195, US

(21) Appl. No.: 11/990,940

(22) PCT Filed: Aug. 28, 2006
(86) PCT No.: PCT/AU2006/001250

§ 371 Date: Mar. 25, 2009

(30) Foreign Application Priority Data
Aug. 26, 2005 (AU) 2005904654
Aug. 29, 2005 (AU) 205904691

(51) Int. Cl. F02B 69/06; F01N 3/10; F02B 17/00; F01L 1/34

(52) U.S. Cl. 123/21; 60/299; 123/295; 123/90.15

(57) ABSTRACT

An internal combustion engine (10) has at least one combustion chamber (15) defined by a piston (13) accommodated in a cylinder (11). The method of operating the engine (10) comprises opening an exhaust means (30) as the combustion chamber (15) expands to permit fluid to discharge from the combustion chamber (15), opening an inlet means (20) as the combustion chamber continues to expand to admit the intake air into the combustion chamber (15); closing the exhaust means (30) as the combustion chamber still continues to expand to interrupt discharge of fluid from the combustion chamber (15), and closing the inlet means (20) to interrupt admission of the intake air into the combustion chamber (15). With this operating sequence, scavenging of the combustion chamber (15) is incomplete and so there is a relatively large residual fluid within the combustion chamber.

### FIELD OF THE INVENTION

This invention relates to engine control strategies for internal combustion engines. In certain applications, the invention may be applicable to an engine system capable of operating in either two-stroke or four-stroke combustion cycles and switching between the two-stroke and four-stroke combustion cycles.

### BACKGROUND ART

A reciprocating internal combustion engine operating with a two-stroke combustion cycle may be piston ported or alternatively may have valves controlling the induction and exhaust processes. In the case of piston ported designs, port operation is typically symmetrical about the bottom-dead-centre (BDC) position of the piston; that is, the timing of opening of the inlet port before BDC position is approximately equal to the timing of closing of the inlet port after BDC, and the timing of opening of the exhaust port before BDC is also approximately equal to the timing of opening of the exhaust port after BDC. Typically, there is some overlap whereby the inlet and exhaust ports are open simultaneously so that the inducted air can assist in clearing (scavenging) the combustion chamber of exhaust gas.

A further problem with an engine operating under the two-stroke cycle is the short-circuiting of fresh charge from the intake port to the exhaust port which increases fuel consumption and emissions of unburned hydrocarbons.

Gasoline engines for automotive applications almost exclusively use four-stroke combustion cycles due to the favourable combination of good engine efficiency over a wide range of operating conditions, low emissions, high levels of refinement (noise and vibration) and high reliability. The two-stroke combustion cycle can offer some advantages in specific areas of operation compared to a four-stroke combustion cycle, including low engine speed performance; reduced vibration at low engine speeds and, when coupled with control over the inlet and exhaust phases, potential for reduced fuel consumption for an engine that can switch between two-stroke and four-stroke operation.

The challenge for most of the world's automobile manufacturers, faced predominantly in Europe, is to reduce the vehicle fuel consumption, not only during the legislated test procedure, but also for real world customer driving. Many of the current technologies address only one of these areas (that is either legislated test procedure or real world driving).

Gasoline engine lean burn technology is one area where much development has occurred in the last 10 years, and offers the largest reduction in fuel consumption for a given engine displacement. Lean burn engines, however, have not penetrated successfully into the market place, and in fact output volumes are reducing, with many manufacturers replacing their current lean-burn engines with engines that operate at stoichiometric air-fuel ratio. This is primarily due to the very high cost associated with the after-treatment of the emissions during lean operation. As well, lean operation has been found to be limited, leading to reduced or even no benefit achieved for many driving conditions, this offering little advantage over the stoichiometric combustion systems currently in production.

Currently more focus is being placed on stoichiometric operation combustion systems, due to simplicity and low cost of the after-treatment systems. New techniques for fuel consumption reduction are being investigated including downsizing and turbo-charging (adopting a smaller engine with higher specific output) in order to maintain a stoichiometric combustion system, and increase the engine operating efficiency. As well, adopting a combustion system which utilises existing three-way catalyst technologies (application for stoichiometic operation), the technology is suitable for all of the advanced vehicle markets, including USA, Japan and China. In order to further improve the engine efficiency of a stoichiometric combustion system for greater reduction in fuel consumption, the inlet pumping work (work required to draw the inlet air into the cylinder past a throttle) at part load operation needs to be reduced. Currently, the introduction of EGR (exhaust gas residuals) is used to increase the charge dilution at part load operation in order to increase the volume of cylinder charge, and therefore reducing inlet pumping losses. This technique typically leads to reductions in the order of 2 to 5% In fuel consumption for typical vehicle driving conditions.

It Is against this background that the present invention has been developed.

### DISCLOSURE OF THE INVENTION

According to a first aspect of the present invention there is provided a method of operating an internal combustion engine, the engine having at least one combustion chamber adapted to undergo expansion and contraction between maximum and minimum volume conditions, an inlet means for admitting an intake fluid into the combustion chamber, and an exhaust means for discharging fluid from the combustion chamber, the method comprising opening the exhaust means as the combustion chamber expands to permit fluid to discharge from the combustion chamber, opening the inlet means as the combustion chamber continues to expand to admit the intake fluid into the combustion chamber, closing the exhaust means as the combustion chamber still continues to expand to interrupt discharge of fluid from the combustion chamber, and closing the inlet means to interrupt admission of the intake fluid into the combustion chamber.

Preferably, the intake means is closed after the combustion chamber has reached its maximum volume condition and during subsequent contraction thereof.

Preferably, the intake fluid comprises a gas and the gas comprises an oxidant.

The intake fluid may comprise either air or an air-fuel mixture.

Where the intake fluid comprises an air-fuel mixture, the fuel may be introduced into the air in any appropriate way, such as for example conventional manifold or port fuel injection.

Preferably, a stoichiometric ratio of oxidant to fuel exists in the combustion chamber at the time of combustion.

Preferably, the engine comprises a 3-way exhaust gas catalyst for the simultaneous treatment of NOx and HC's

The method may further comprise direct injection of fuel into the combustion chamber. This is necessary in the case where the intake fluid comprises air without fuel entrained therein.

Preferably, the fuel Is delivered during contraction of the combustion chamber such that no unburnt fuel escapes through the exhaust means.

Preferably, the fuel is delivered after closing of the exhaust means.

The fuel may be delivered using a dual fluid injection system.

In the case that the dual fluid injection system utilises air as the propellant to deliver the fuel to the engine, preferably the fuel injection event is timed so that unburnt oxygen in the air does not escape through the exhaust means. Typically this would entail timing the fuel delivery event to be close to, or after, the exhaust means is closed. Preferably, the fuel injection system comprises a fuel metering injector and a mixture delivery injector, the mixture delivery injector having a holding chamber into which the fuel metering injector delivers the fuel, the holding chamber being exposed to pressurised gas for delivery of an gas-fuel mixture to the combustion chamber.

Typically, the engine comprises a reciprocating engine comprising a cylinder within which the combustion chamber is defined and which accommodates a reciprocating piston, the maximum volume condition of the combustion chamber corresponding to the bottom-dead-centre (BDC) position of the piston and the minimum volume condition corresponding to the top-dead-centre (TDC) position of the piston.

The inlet means typically comprises at least one inlet port and an inlet valve for opening and closing the inlet port. Further, the outlet means typically comprises at least one exhaust port and an exhaust valve for opening and closing the exhaust port.

The valves may be controlled for movement between their respective open and closed conditions In any appropriate way. The valves may, for example, be operated mechanically, electro-mechanically, hydro-mechanically, electro-hydraulically or pneumatically.

With operation of the engine by the method according to the invention, the exhaust port Is opened and closed while the combustion chamber undergoes volume expansion, with fluid pressure within the combustion chamber being utilised to effect discharge of exhaust gas therefrom. In this way, there are no pumping losses associated with the exhaust process.

In prior art applications it has been known to allow a significant degree of overlap between the intake valve open phase and the exhaust valve open phase (commonly referred to as valve overlap). In such prior art cases this overlap can provide benefits in terms of better scavenging and volumetric efficiency as it allows for fluid dynamic effects. Such significant valve overlap can cause some short circuiting of the intake air directly to the exhaust.

For the present Invention, it is desirable to eliminate, or at least minimise, any short circuiting of the Intake charge to the exhaust. This can be done by ensuring zero overlap between the intake valve open phase and the exhaust valve open phase.

It has been found that a more preferable arrangement is for there to be a small degree of overlap so that there is no stage during the expansion stroke of the piston that the combustion chamber is completely sealed as this would lead to pumping losses as the piston would continue its expansion stroke against a closed combustion chamber thus creating a negative pressure (also known as “over-expansion”). In such case the degree of valve overlap is controlled to minimise pumping losses.

Because there is deliberately little opportunity for clearing the exhaust gas from the combustion chamber some exhaust gas is consequently retained in the combustion chamber. Furthermore, less time is available for the fresh intake charge to cool the combustion chamber.

The presence of retained exhaust gas in the combustion chamber can prove to be useful, as it establishes a higher initial temperature within the combustion chamber at the point of ignition. The retained exhaust gases may also contribute to a reduction in pumping and throttling losses in the induction process, as a reduced volume of air is inducted. The retained exhaust gases also dilute the inducted air, which may assist in operation of the combustion process at stoichiometric conditions.

It is desirable to operate the engine such that it is only necessary to use a conventional catalytic converter, such as a three-way catalytic converter. This requires that there be stoichiometric operation (which is typically associated with a homogeneous fuel-air charge), avoiding the need for a lean NOx trap (which is required to absorb NOx gases emitted from an engine operating with excess oxygen present in the exhaust gas, as typically arises in cases where a lean fuel-air mixture is employed).

The engine may be operated in accordance with a two-stroke combustion cycle or a four-stroke combustion cycle.

The method according to the invention may further comprise switching the combustion cycle of the engine between the two-stroke cycle to the four-stroke cycle.

The method may comprise operating the engine with spark ignition. Alternatively, the method may comprise operating the engine with homogenous charged compression ignition (HCCI).

In addition to switching operation of the engine selectively between two and four-stroke operation, the method may involve switching operation of the engine selectively between spark Ignition and HCCI.

Operating an engine by the method according to the invention may possibly address some of the difficulties associated with downsizing of engines in order to meet certain emission targets while providing acceptable driveability.

An engine operated by the method in accordance with the invention may also be suitable for integration in a hybrid system.

According to a second aspect of the invention there is provided a control system for an internal combustion engine having at least one combustion chamber adapted to undergo expansion and contraction between maximum and minimum volume conditions, an inlet means for admitting an intake fluid into the combustion chamber and an exhaust means for discharging fluid from the combustion chamber, the control system being adapted to operate the engine with a combustion cycle comprising opening the exhaust means as the combustion chamber expands to permit fluid to discharge from the combustion chamber, opening the inlet means as the combustion chamber continues to expand to admit intake fluid into the combustion chamber, closing the exhaust means as the combustion chamber still continues to expand to interrupt discharge of fluid from the combustion chamber, and closing the inlet means after closing the exhaust means to interrupt admission of intake fluid into the combustion chamber.

Preferably, the control system Is adapted to switch operation of the engine from a two-stroke combustion cycle to a four-stroke combustion cycle, and to selectively switch between the two-stroke and four-stroke combustion cycles.

The switch between the two-stroke and four-stroke combustions cycles may be achieved by varying valve timing and duration of valve opening.

According to a third aspect of the invention there is provided an engine comprising at least one combustion chamber adapted to undergo expansion and contraction between maximum and minimum volume conditions, an inlet means for admitting an intake fluid into the combustion chamber, an exhaust means for discharging fluid from the combustion chamber, and a control system for controlling operation of the inlet means and the exhaust means, the control system being adapted in one mode of operation to open the exhaust means as the combustion chamber expands to permit fluid to discharge from the combustion chamber, open the inlet means as the combustion chamber continues to expand to admit Intake fluid into the combustion chamber; close the exhaust means as the combustion chamber still continues to expand to interrupt discharge of fluid from the combustion chamber, and close the inlet means after closing of the exhaust means.

The engine may operate in a two-stroke combustion cycle or a four-stroke combustion cycle. Further, the engine may be switched selectively between the two-stroke and the four-stroke combustion cycles.

The engine may further comprise an exhaust system comprising a three-way catalytic converter.

Preferably the exhaust system does not comprise a catalyst capable of absorbing or otherwise treating NOx in an oxygen rich (ie lean) environment.

### BRIEF DESCRIPTION OF THE DRAWINGS

The invention will be better understood by reference to the following description of one specific embodiment thereof as shown in the accompanying drawings in which:

FIG. 1 is a schematic view of an engine operated in accordance with the embodiment, the engine being switchable between two-stroke and four-stroke combustion cycles;

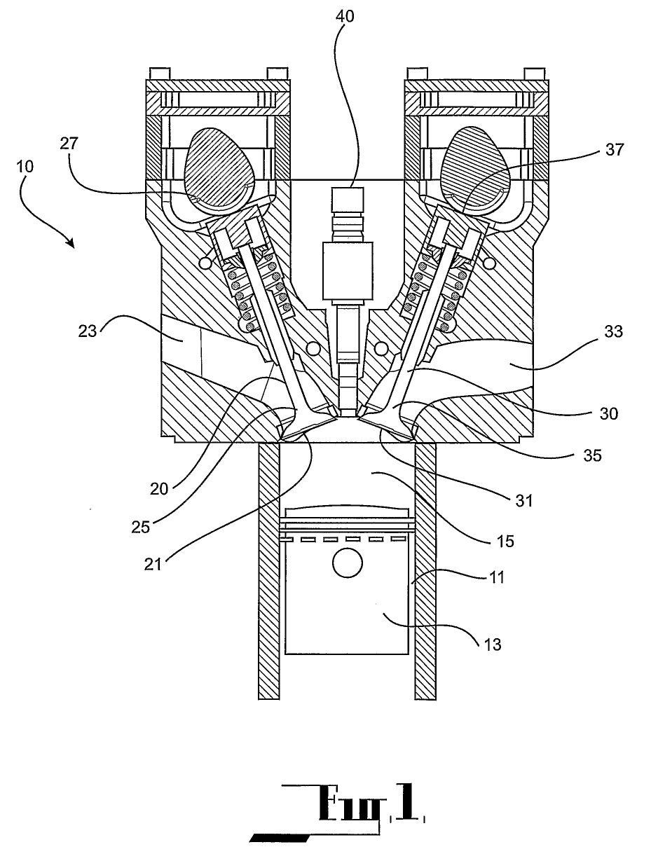

FIG. 2 is a comparative diagram showing inlet and exhaust valve lift during operation of the engine in both two-stroke and four-stroke cycles;

FIG. 3 is a cycle diagram illustrating the relative timing of operation of inlet and exhaust valves of the engine when operating in a two-stroke combustion cycle in a condition for optimum torque delivery;

FIG. 4 is a further cycle diagram illustrating the relative timing of operation of inlet and exhaust valves of the engine when operating in a two-stroke combustion cycle in a condition for optimum fuel consumption; and

FIG. 5 is a comparative graph showing the bulk cylinder gas temperature during operation of the engine in both two-stroke and four-stroke cycles.

### BEST MODE(S) FOR CARRYING OUT THE INVENTION

The embodiment is directed to a reciprocating internal combustion engine 10 which is capable of operating in either two-stroke or four-stroke cycles of operation, with selective switching therebetween.

The engine 10 comprises a cylinder 11 and a piston 13 accommodated in the cylinder. The cylinder 11 and piston 13 cooperate to define a combustion chamber 15. The combustion chamber 15 undergoes volume expansion and contraction upon reciprocatory movement of the piston 13 within the cylinder 11 between top-dead-centre (TDC) and bottom-dead-centre (BDC) positions.

An inlet means 20 is provided for introducing an air charge into the combustion chamber and an outlet means 30 is provided for discharging exhaust gas fro in the combustion chamber.

The inlet means 20 comprises an inlet port 21 opening onto the combustion chamber 15 at the terminal end of a delivery duct 23, and an inlet valve 25 for opening and closing the inlet port 21. A control means 27 is provided for controlling operation of the inlet valve 25 to cause opening and closing thereof.

The exhaust means 30 comprises an exhaust port 31 opening onto the combustion chamber 15 at the entry end of a discharge duct 33 and exhaust valve 35 for opening and closing the exhaust port. A control means 37 Is provided for controlling operation of the exhaust valve 35 to cause opening and closing thereof.

The control means 27, 37 for controlling opening and closing of the inlet and exhaust valves may take any appropriate form. The valve control means 27, 37 may, for example, comprise mechanical control mechanisms such as cams on a camshaft.

A fuel injection system 40 is provided for direct injection of fuel into the combustion chamber. In this embodiment the fuel Injection system comprises a dual fluid fuel injection system of the type disclosed in U.S. Pat. No. RE 36768 and International Application WO 99128621, the contents of both of which are incorporated herein by way of reference. The use of an oxygenated gas, such as air, to deliver fuel to a combustion chamber can have particularly beneficial effects when high internal EGR amounts are used, such as can occur in the present embodiment.

An ignition device (not shown), such as a spark plug, is provided for Igniting a combustion mixture charge in the combustion chamber 15 at appropriate timings.

The exhaust duct 33 communicates with an exhaust system (not shown) incorporating a catalytic converter in the form of a conventional three-way catalytic converter.

The engine can be operated In a two-stroke combustion cycle or a four-stroke combustion cycle, and can be switched therebetween according to the operational demand on the engine.

Operation of the engine in the four-stroke cycle can offer the favourable combination of good engine efficiency over a wide range of operating conditions, low emissions, high level of refinement (noise and vibration) and high reliability.

The two-stroke combustion cycle can offer some advantages in specific areas of operation compared to a four-stroke engine, including low speed engine performance, reduced vibration at low engine speeds, and when coupled with control over the inlet and exhaust phases, potential for reduced fuel consumption. In order to exploit the benefits of both four-stroke and two-stroke combustion cycles, the engine Is capable of switching between these two modes of operation. Switching is controlled in such a way as to be transparent to an operator or user of such engine.

The determining factor as to whether the engine operates in the two-stroke cycle or the four-stroke cycle is the timing of operation of the intake and exhaust valves 25, 35 as well as the duration of opening of the valves.

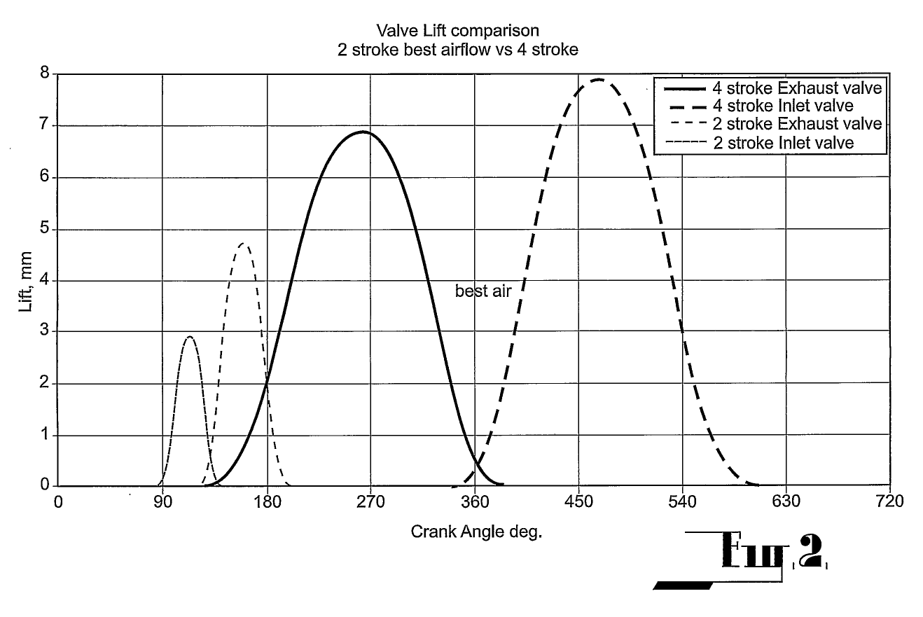

The inlet and exhaust valves 25, 35 operate at double the frequency of actuation in the two-stroke cycle as compared to the four-stroke cycle. Specifically, the inlet and exhaust valves 25, 35 acuate once for each rotation of the engine crankshaft (i.e. each 360°) in the two-stroke cycle, whereas they actuate once for each two rotations (i.e. each 720°) of the engine crankshaft in the four-stroke cycle, as is evident from FIG. 2 which is a comparative diagram showing inlet and exhaust valve lift. It is, of course, necessary for the valve control means 27, 37 to accommodate the cycle switching.

Further, it may be that the engine 10, when operating in a two-stroke combustion cycle, does not perform combustion stoke on every engine cycle. The engine 10 may, for example, perform a combustion stroke at intervals (such as on alternate cycles) in order to afford improved fuel consumption in certain operating conditions. Similarly, it may be that the engine 10, when operating in a four-stroke combustion cycle, does not perform combustion stoke on every alternate engine cycle.

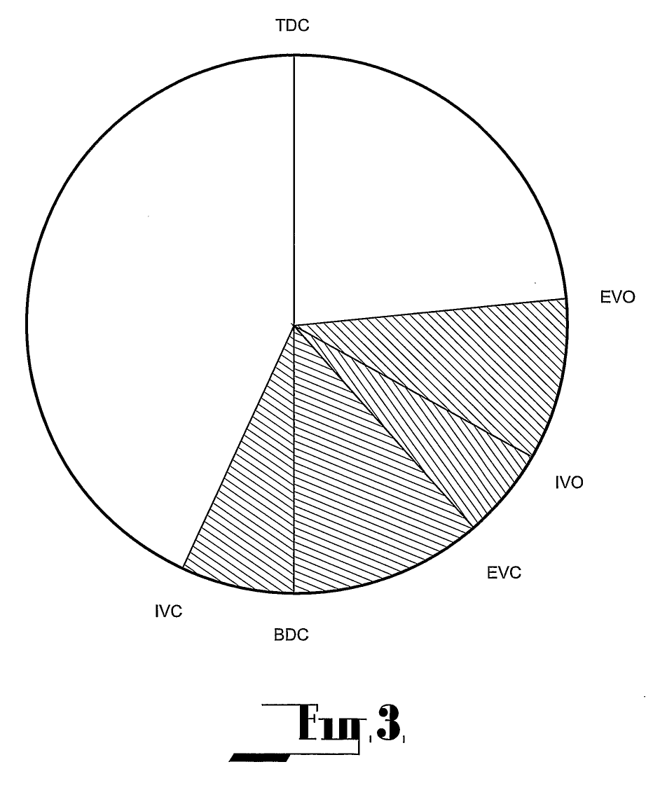

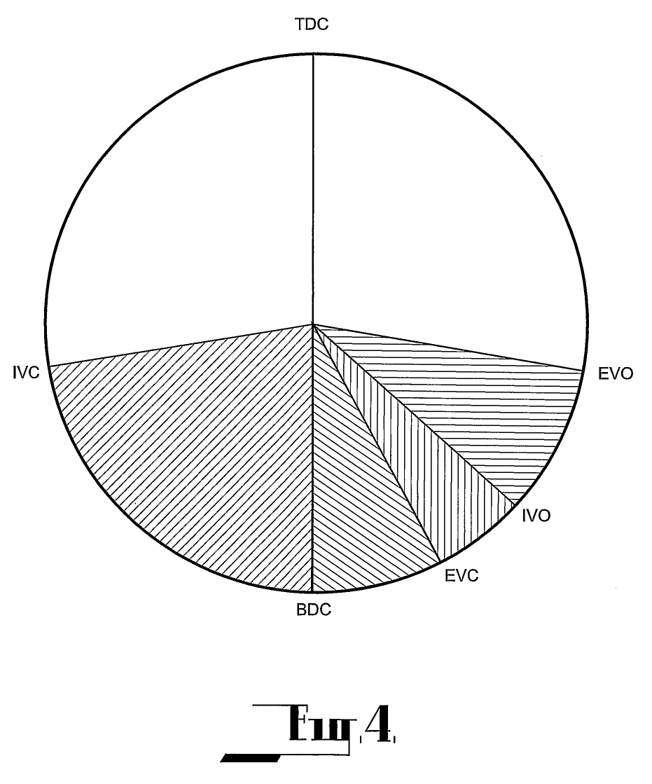

In addition to switching between two-stroke and four-stroke cycles of operation, the engine according to the embodiment can operate under a particular control strategy in the two-stroke cycle for low engine speed and load conditions. The particular control strategy is illustrated in FIGS. 3 and 4 which are cycle diagrams depicting the relative timing of operation of the inlet and exhaust valves 25, 35.

The strategy involves:
(1) opening the exhaust valve 35 during the power stroke (as indicated by point EVO on each cycle diagram);
(2) opening the Inlet valve 25 (as indicated by point IVO) near the end of when the exhaust valve 35 is closing (or alternatively, but not shown on the drawings, opening the inlet valve after the exhaust valve has closed);
(3) closing the exhaust valve 35 during the power stroke prior to BDC (as indicated by point EVC); and
(4) closing the inlet valve 25 during the subsequent compression stroke (as indicated by point IVC).

With this control strategy, the exhaust port 31 opens and closes before BDC, and the pressure differential between the combustion chamber 15 and the exhaust system is utilised to effect discharge of exhaust gas from within the chamber (commonly referred to as “blow-down”). Because of little or no overlap in opening of the inlet port 21 and the exhaust port 31 (being the interval between IVO and EVC in the cycle diagrams), there is little or no scavenging of the remaining exhaust gas. As such, there is little short-circuiting of the intake air between the open intake port 21 and the open exhaust port 31.

Because of the limited period of valve opening overlap, scavenging of the combustion chamber 15 is incomplete and so there is a relatively large residual exhaust gas within the combustion chamber. The presence of residual exhaust gas in the combustion chamber 15 can prove to be useful, as it establishes a higher initial temperature within the combustion chamber at the point of ignition. The residual exhaust gases may also contribute to a reduction in pumping and throttling losses in the induction process, as a reduced volume of air is inducted through the Inlet means 20. The residual exhaust gases also dilute the inducted air, which may assist in operation of the combustion process at stoichiometric conditions. The stoichiometric operation allows use of the three-way catalytic converter without the need for a lean NOx trap (which would otherwise be required to absorb NOx gases emitted from an engine operating with excess oxygen present in the exhaust gas).

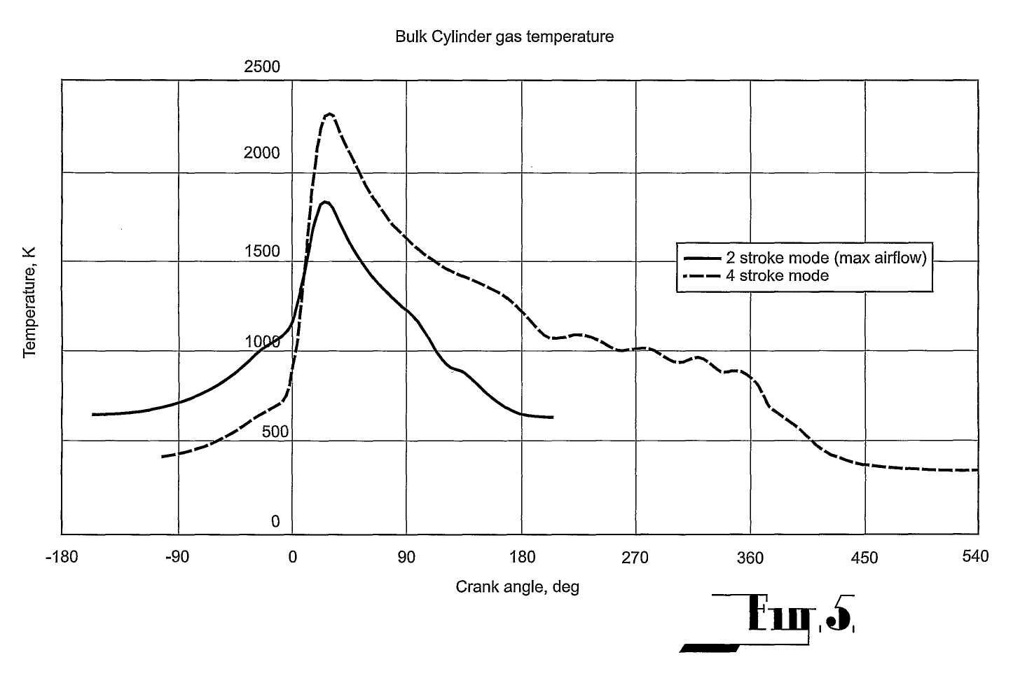

Additionally, because of the higher temperature of the retained EGR there is a higher temperature during the initial combustion phase. This is evident from the graph of FIG. 5 which provides a comparison of the bulk cylinder operating temperatures for the two-stroke and four-stroke cycles through the duration of the cycles. From the graph, it can be seen that the bulk cylinder temperature at TDC (being a crank angle of 0° in the graph) Is significantly higher for the two-stroke cycle in comparison to the four-stroke cycle. The higher bulk cylinder gas temperature in the two-stroke cycle may assist the combustion characteristics of the combustible mixture within the combustion chamber 15 (which includes the residual exhaust gas). It will also be noted from FIG. 5 that whilst the initial temperature prior to combustion is higher, the peak combustion temperature, when operating In the inventive mode, is lower than in the conventional 4-stroke cycle operation. This leads to lower NOx production.

Because of the high temperatures and high dilution levels during operation of the engine 10 in the two-stroke cycle, stratified charge Ignition systems, pre-chamber ignition systems and homogeneous charge compression ignition (HCCI) may have particular applicability to ensure proper ignition of the charge.

The relatively high bulk cylinder temperature at ignition in the two-stroke cycle may create conditions which are favourable to implementation of HCCI at certain operating conditions of the engine.

The time at which the inlet valve 25 is closed can be used to control certain operating characteristics of the engine 10. By way of example, early closing of the inlet valve 25 as depicted in the cycle diagram of FIG. 3 provides an engine operating condition conducive to maximise trapped fresh charge for optimum torque delivery. In contrast, retarding closure of the inlet valve 25, as illustrated in the cycle diagram of FIG. 4, provides an engine operating condition which is conducive to optimum fuel consumption. Late closing of the inlet valve typically requires boosted inlet conditions to obtain sufficient trapped charge for load requirements. Late closing of the inlet valve minimises compression losses which can be associated with timings to achieve highest trapped charge conditions, and therefore can provide lower fuel consumption.

From the foregoing, it is evident that the present embodiment provides a simple yet highly-effective strategy for operating an engine in a two-stroke combustion cycle in certain load conditions in order to reduce pumping losses while at the same time extracting certain benefits arising from operation in a two-stroke cycle. The embodiment also allows switching of the combustion process between the two-stroke and four-stroke cycles. Accordingly, the embodiment addresses some of the difficulties associated with downsizing of engines in order to meet certain emission targets while providing acceptable driveability.

Modifications and improvements can be made without departing from the scope of the invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A method of operating an internal combustion engine, the engine having at least one combustion chamber configured to undergo expansion and contraction between maximum and minimum volume conditions, an inlet for admitting an intake fluid into the combustion chamber, and an exhaust for discharging fluid from the combustion chamber, the method comprising
opening the exhaust as the combustion chamber expands to permit fluid to discharge from the combustion chamber;
opening the inlet as the combustion chamber continues to expand to admit the intake fluid into the combustion chamber;
closing the exhaust as the combustion chamber still continues to expand to interrupt discharge of exhaust fluid from the combustion chamber and thereby retain some exhaust fluid therein; and
closing the inlet to interrupt admission of the intake fluid into the combustion chamber.

2. A method according to claim 1 wherein the intake is closed after the combustion chamber has reached its maximum volume condition and during subsequent contraction thereof.

3. A method according to claim 1 wherein the intake fluid comprises a gas and the gas comprises an oxidant.

4. A method according to claim 1, further comprising directly injecting of fuel into the combustion chamber.

5. A method according to claim 1 wherein the intake fluid comprises an air-fuel mixture.

6. A method according to claim 4 wherein fuel is delivered during contraction of the combustion chamber.

7. A method according to claim 6 wherein the fuel is delivered after closing of the exhaust.

8. A method according to claim 4, wherein the fuel is entrained in pressurised air for delivery to the combustion chamber.

9. A method according to claim 3 wherein the admission of the intake fluid is so timed that that unburnt oxygen in the air does not escape through the exhaust.

10. A method according to claim 9 wherein admission of the intake fluid is close to, or after, the exhaust is closed.

11. A method according to claim 3 wherein the inlet is open during an inlet open phase and the exhaust is open during an exhaust open phase, and wherein there is no overlap between the inlet open phase and the exhaust open phase.

12. A method according to claim 3 wherein the inlet is open during an inlet open phase and the exhaust is open during an exhaust open phase, and wherein there is some overlap between the inlet open phase and the exhaust open phase.

13. A method according to claim 4 wherein a stoichiometric ratio of air to fuel exists in the combustion chamber at the time of combustion.

14. A method according to claim 13 further comprising:
subjecting the exhaust fluid to a 3-way exhaust gas catalyst for the simultaneous treatment of NOx and HCs.

15. A method according to claim 1 wherein the engine is operated in a two-stroke combustion cycle and wherein the method further comprises switching the combustion cycle of the engine between the two-stroke cycle to a four-stroke cycle.

16. A method according to claim 1 further comprising:
operating the engine with spark ignition.

17. A method according to claim 1 further comprising:
operating the engine with homogenous charged compression ignition.

18. A method according to claim 1 further comprising:
switching operation of the engine selectively between spark ignition and homogenous charged compression ignition.

19. An engine operating in accordance with a method according to claim 1.

20. A control system for an internal combustion engine having at least one combustion chamber configured to undergo expansion and contraction between maximum and minimum volume conditions, an inlet for admitting an intake fluid into the combustion chamber and an exhaust for discharging fluid from the combustion chamber, the control system configured configured to operate the engine with a combustion cycle comprising opening the exhaust as as the combustion chamber expands to permit fluid to discharge from the combustion chamber, opening the inlet as the combustion chamber continues to expand to admit intake fluid into the combustion chamber, closing the exhaust as the combustion chamber still continues to expand to interrupt discharge of fluid from the combustion chamber, and closing the inlet after closing the exhaust to interrupt admission of intake fluid into the combustion chamber.

21. A control system according to claim 20 wherein the control system is configured to switch operation of the engine between a two-stroke combustion cycle and a four-stroke combustion cycle.

22. A control system according to claim 21 wherein the switch between the two-stroke and four-stroke combustions cycles is achieved by varying valve timing and duration of valve opening.

23. An engine comprising:
at least one combustion chamber configured to undergo expansion and contraction between maximum and minimum volume conditions;
an inlet for admitting an intake fluid into the combustion chamber;
an exhaust for discharging fluid from the combustion chamber; and
a control system for controlling operation of the inlet and the exhaust, the control system configured in one mode of operation, to open the exhaust as the combustion chamber expands to permit fluid to discharge from the combustion chamber, open the inlet as the combustion chamber continues to expand to admit intake fluid into the combustion chamber, close the exhaust means as the combustion chamber still continues to expand to interrupt discharge of fluid from the combustion chamber, and close the inlet after closing of the exhaust.

24. An engine according to claim 23 further comprising:
a cylinder within which the combustion chamber is defined and which accomodates a reciprocating piston, the maximum volume condition of the combustion chamber corresponding to the bottom-dead-centre position of the piston and the minimum volume condition corresponding to the top-dead-centre position of the piston.

25. An engine according to claim 23 wherein outlet comprises:
at least one exhaust port; and
an exhaust valve for opening and closing the at least one exhaust port.

26. An engine according to claim 23, wherein the inlet comprises:
at least one inlet port; and
an inlet valve for opening and closing the at least one inlet port.

27. An engine according to claim 23 wherein the intake fluid comprises a gas and the gas comprises an oxidant.

28. An engine according to claim 27 wherein the gas comprises air and the oxidant comprises oxygen in the air.

29. An engine according to claim 28 wherein the intake fluid comprises an air-fuel mixture.

30. An engine according to claim 27 wherein the gas comprises a pressurised gas to which the fuel is exposed for delivery of an gas-fuel mixture to the combustion chamber

31. An engine according to 29 further comprising:
a fuel injection system for delivery of a metered quantity of the fuel to the combustion chamber entrained in the body of gas.

32. An engine according to claim 31 wherein the fuel injection system comprises:
a fuel metering injector; and
a mixture delivery injector, the mixture delivery injector having a holding chamber into which the fuel metering injector delivers the fuel, the holding chamber being exposed to the pressurised gas for delivery of the gas-fuel mixture to the combustion chamber.

33. An engine according to claim 32 further comprising:
a compressor for supplying pressurised gas to the fuel injection system.

34. An engine according to claim 27 wherein a stoichiometric ratio of oxidant to fuel exists in the combustion chamber at the time of combustion.

35. An engine according to claim 23 further comprising:
an exhaust system comprising a three-way catalytic converter.

36. An engine according to claim 23 wherein the control system is configured to operate the engine in a two-stroke combustion cycle.

37. An engine according to claim 23 wherein the control system is configured to operate the engine in a four-stroke combustion cycle.

38. An engine according to claim 23 wherein the control system is configured to switch operation of the engine between a two-stroke combustion cycles to a four-stroke combustion cycle.

39. An engine according to claim 38 further comprising:
for varying the timing and duration of operation of the inlet and exhaust to switch between the two-stroke and four-stroke combustions cycles.

40. An engine according to claim 23 wherein the engine is configured to operate with spark ignition.

41. An engine according to claim 23 wherein the engine is configured to operate with homogenous charged compression ignition.

42. An engine according to claim 23 wherein the engine is configured to operate with either spark ignition or homogenous charged compression ignition and to switch therebetween.

43. An engine according to claim 23 wherein the exhaust is closed during volume contraction of the combustion chamber.

44. An engine according to claim 23 wherein opening and closing of the exhaust is substantially symmetrical about the maximum volume condition of the combustion chamber.

45. An engine according to claim 23 wherein the metered quantity of fuel entrained in gas is delivered into the combustion chamber near to or after closing of the exhaust means and during volume contraction of the combustion chamber.

46. An engine according to claim 23 wherein the inlet is opened to admit the intake fluid into the combustion chamber after opening of the exhaust and while the combustion chamber continues to expand.

47. An engine according to claim 23 wherein fuel is delivered to the combustion chamber shortly before the exhaust is closed.

48. An engine according to claim 23 wherein fuel is delivered to the combustion chamber after the exhaust is closed.

49. (canceled)

50. (canceled)

51. (canceled)
